(19) United States
(12) Patent Application Publication
(10) Pub. No.: US 2020/0244775 A1
(43) Pub. Date: Jul. 30, 2020

(54) Systems and Methods of Accessing Nested Asset Information

(71) Applicant: Concourse Federal Group, Washington, DC (US)

(72) Inventor: Brenden Jay Smith, Lake Ridge, VA (US)

(21) Appl. No.: 16/258,465

(22) Filed: Jan. 25, 2019

(51) Int. Cl. H04L 29/06; H04L 29/08; G06F 16/909; G06F 16/955

(52) U.S. Cl. CPC H04L 67/42; H04L 67/34; G06F 16/9566; G06F 16/909; H04L 67/16

(57) ABSTRACT

Systems and methods of the inventive subject matter allow users to access asset information at the room level after making a series of selections including selecting a region, selecting a location, selecting a structure, selecting a floor, and finally selecting a room. In some embodiments, users can additionally view details related to a selected asset within a room. The inventive subject matter is directed to interactions between clients and servers to bring about these results, emphasizing the necessary communications that must move back and forth between client and server.

### FIELD OF THE INVENTION

The field of the invention is systems and methods of accessing nested asset information.

### BACKGROUND

The background description includes information that may be useful in understanding the present invention. It is not an admission that any of the information provided in this application is prior art or relevant to the presently claimed invention, or that any publication specifically or implicitly referenced is prior art.

Construction, development, and building management all give rise to a need to keep track of vast amounts of information. For example, in the course of managing a project it can be important to be able to easily locate all assets located in a particular room of a building. But, for example, when a company manages buildings and projects all over a continent or the globe, it can be difficult to sort through hundreds or even thousands of assets controlled by that company.

This gives rise to a need for an easily accessible building management platform that is capable of handling vast amounts of information in an easy-to-use manner. To organize asset information when assets are spread across an entire continent, it has yet to be appreciated that assets can be sorted into rooms, rooms sorted into floors, floors sorted into buildings, buildings sorted into locations, and locations sorted into regions. Such a nested data structure can facilitate easy lookup of assets down to the room level from a continent view of a plurality of regions.

Thus, there exists a need for improved building and construction management systems and methods that are designed to facilitate asset lookup and identification across many different projects located all over the world. It has yet to be appreciated that improved systems and methods of asset management can be achieved by implementing well-organized data structures configured to store and organize assets related to building management and development.

### SUMMARY OF THE INVENTION

In one aspect of the inventive subject matter, a method of accessing development project assets is contemplated. The method includes the steps of: receiving a region locations request at the server, the region locations request comprising a selected region; sending a region locations response from the server, the region locations response comprising at least one set of location parameters corresponding to the at least one location located in the selected region; receiving a location structures request comprising a selected location and the selected region; sending a location structures response comprising at least one set of structure type parameters and at least one set of structure parameters; receiving a structure floor request comprising a selected structure, the selected location, and the selected region; sending a structure floors response comprising at least one set of floor parameters; receiving a floor plan request, comprising a selected floor, the selected location, the selected structure, and the selected region; sending a floor plan response comprising at least one set of room parameters and at least one set of primary use parameters; receiving a room asset request comprising a selected room, the selected floor plan, the selected location, the selected structure, and the selected region; and sending a room asset response, comprising at least one set of asset parameters and at least one set of asset model parameters.

In some embodiments, the region locations request further comprises a load region locations request to load at least one location corresponding to the selected region. The at least one set of location parameters can include at least one of a location city, a location description, a location name, a location state, a location structure total, a location zip code, and a region ID. In some embodiments, the load structures request further comprises a load structures action request to load the at least one set of structure type parameters and to load the at least one set of structure parameters, both corresponding to the selected location.

In some embodiments, the at least one set of structure type parameters comprises at least one of a structure type color, a structure type description, and a structure type label. The at least one set of structure parameters can include at least one of a structure city, a structure description, a structure location, a structure address, a structure marker position, a structure name, a structure square footage, a structure state, a structure type, and a structure zip code.

In some embodiments, the structure floors request further comprises a load floors action request to load the at least one set of floor parameters corresponding to a floor within the selected structure. The at least one set of floor parameters can include at least one of a floor description, a floor structure ID, the dataset ID, a floor number, a floor map URL, a floor image, a floor name, a floor square footage, and a floor map. In some embodiments, the floor plan request further comprises a load rooms action request to load the at least one set of room parameters and to load the at least one set of primary use parameters, both corresponding to the selected floor.

In some embodiments, the at least one set of room parameters comprises at least one of a room layout option, a room link, a primary use, a room map, a room square footage, a room area, a room number, a room name, a room description, a room capacity, a room image, a room panorama URL, a room parent, a room map URL, and a room floor. The at least one set of primary use parameters can include at least one of a primary use color, a primary use description, and a primary use label.

In some embodiments, the room asset request further comprises a load room assets action request to load the at least one set of asset parameters and to load the at least one set of asset model parameters, both corresponding to at least one asset located in the selected room. The at least one set of asset parameters can include at least one of an asset color, an asset description, and an asset label.

In some embodiments, the at least one set of asset model parameters comprises at least one of: an asset photo URL, an asset number, an asset hotspot, an asset model, an asset photo, an asset manufacturer, an asset serial number, an asset QR code, an asset area, an asset name, an asset parent, an asset description, an asset type, and an asset room location.

In some embodiments, methods of the inventive subject matter include the additional steps of: receiving an asset detail request that includes a selected asset and one or any combination of the selected room, the selected floor plan, the selected location, the selected structure, the selected region, and a display asset details action request to cause display of a set of asset details corresponding to the selected asset; and sending an asset detail response comprising information sufficient to cause display of the set of asset details on a computing device.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a flowchart showing a preliminary data loading process.

FIG. 2 is a flowchart showing a data collection process.

FIG. 3 is a flowchart showing a data processing process.

FIG. 4A is a flowchart of an embodiment of the inventive subject matter.

FIG. 4B shows client and server interactions corresponding to FIG. 4A.

FIG. 5A is a flowchart showing additional steps that can be included in another embodiment of the inventive subject matter.

FIG. 5B shows client and server interactions corresponding to FIG. 5A.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Throughout this application some terms are used that should be interpreted more broadly than their plain language may suggest. For example, when the application refers to “square footage” or “square feet,” this language should be interpreted as covering all different units of measurement (e.g., yards, meters, etc.). Moreover, all parameters discussed in this application can be expressed in a wide variety of ways including by plain text, by unique identifier, by encrypted text, and so on. All of these different ways of expressing a particular parameter are contemplated any time a parameter is discussed or disclosed. Any data entry described in this application that can be accomplished by a system administrator can alternatively be accomplished by a user or users (e.g., crowdsourcing or user-level administration).

Systems and methods of the inventive subject matter are directed to asset management and control in the context of, for example, construction and building management and development. For example, in building development, construction, and building management, it can be difficult to organize and keep track of assets (e.g., hardware, furniture, HVAC, etc.) that are located within rooms in a structure. Not only that, it can be even more challenging when a need exists to keep track of hundreds, or thousands, of assets spread across rooms in different structures in different locations all over the world. Embodiments of the inventive subject matter facilitate retrieval of asset information that is stored according to region, location, structure, floor, and finally room.

Embodiments of the inventive subject matter facilitate access to information stored in remotely stored databases. To make the information accessible, the information must first be loaded, collected, and processed. This ensures information stored according to embodiments of the inventive subject matter is stored in data structures that facilitate remote access. Information can be stored according to region, location, structure, floor, room, and asset, or any subset of these categories. Each category is organized according to the previous category, and in some embodiments, categories can be omitted entirely (e.g., a region can be selected and then a listing of structures can be returned instead of a listing of locations). In a typical embodiment, when a user selects a region, they are presented with a listing of locations within the region, and when the user then selects a location, they are presented with a listing of structures within the selected location, and so on.

Information can be presented visually, beginning with, for example, a map of a continent showing different regions. When a region is selected, the map changes zoom and focus to the selected region. When a location is selected, the map changes zoom and focus to show the selected location. When a structure is selected, the map against changes zoom and focus to show the selected structure. Next, when a floor is selected within the selected structure, a floor plan can be presented to the user showing the different rooms on that floor along with a listing of rooms. The user can then select a room to cause the system to present a listing of assets located in that room, and so on.

Regions, locations, structures, floors, rooms, and assets can all be defined by a user or system administrator. For example, a region can be created by drawing a region's boundaries on a map, or a region can be defined by a series of latitude and longitude pairs that create a geofence of the region.

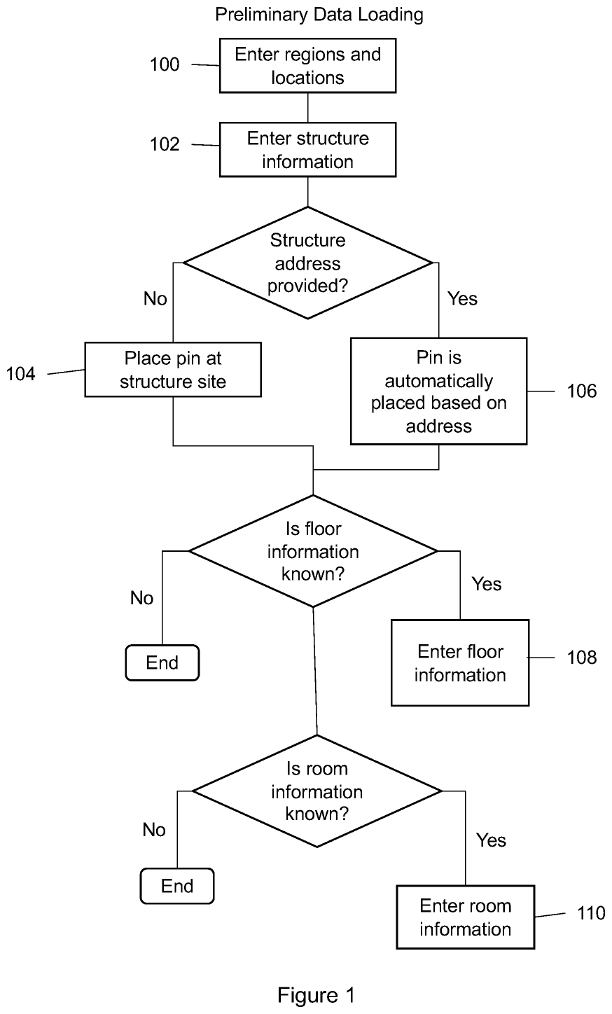

FIG. 1 is a flow chart demonstrating an embodiment of preliminary data loading. These steps can be carried out by, for example, a system administrator with access to a remote server or set of servers that are configured to carry out the functions of the inventive subject matter (the “platform server”). This flowchart shows steps involved in adding data (e.g., region, location, building, floor, and asset data) into a structure that facilitates organization and easy access to that data at a later time. In step 100, regions and locations are entered into a data structure stored on the platform server. Regions and locations, along with any associated information or metadata, can be either imported from an existing database or manually entered by a system administrator. In step 200, structure information is also entered. If a structure address is provided, then a pin can be automatically placed on a map as shown in step 104, and if no structure address is provided then a pin can be manually placed on a map corresponding to the structure's address as shown in step 106.

Next, if floor information is known and automatically accessible (e.g., via API call, query, or any other mode of data retrieval that facilitates access to remotely stored information), that information is added to the data structure. Floor information that is known can be pulled from, for example, an existing database that is stored either locally (e.g., on a user's computer) or remotely (e.g., in a remotely accessible database on a server or set of servers). But if floor information is unknown and otherwise inaccessible for automatic inclusion, then a prompt can be presented requesting manual entry of floor information, as shown in step 108. Next, if room information is known and automatically accessible (in the same sense as above with regard to floor information), then the room information is added to the data structure. If room information is unknown or otherwise not automatically accessible for inclusion, then a prompt can be presented requesting manual entry of room information, as shown in step 110. Room information can include information related to assets located in each room, the room's location on a floor, the room's dimensions, etc.

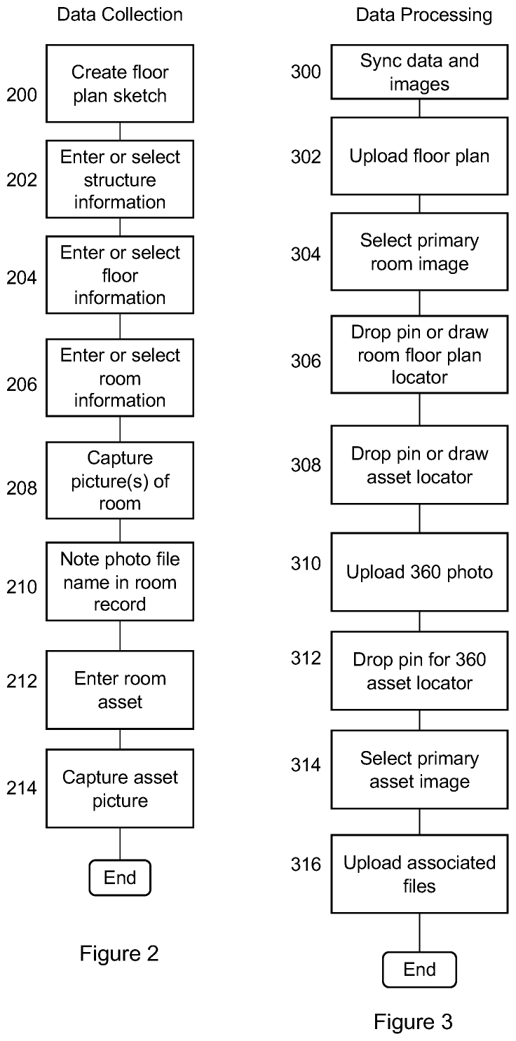

FIG. 2 is a flowchart demonstrating data collection according to the inventive subject matter. These steps can be carried out by, for example, a user or a system administrator with access to the platform server. Although the steps in FIG. 2 are shown as occurring in sequence, the sequence of steps is not restricted only to the presented sequence. Steps can be omitted or re-ordered according to the requirements of different embodiments. Step 200 requires creation of a floor plan sketch. For example, when a user selects a floor plan, embodiments causes presentation of a floor plan sketch to give the user a visual representation of the selected floor plan. Thus, a floor plan sketch can first be created and added to the platform server. A floor plan sketch can be created for use with embodiments of the inventive subject matter by importing or otherwise creating the floor plan sketch (e.g., in CAD software) and then importing or uploading the floor plan sketch onto the platform server or another remote server that the platform server can access to retrieve the floor plan.

Step 202 requires entry or selection of structure information. In instances where structure information is not accessible for import to the platform server from an existing database, structure information can be manually entered into a database on the platform server. Step 204 requires entry or selection of floor information. In instances where floor information is not accessible for import to the platform server from an existing database, floor information can be manually entered into a database on the platform server (or, e.g., a separate server that the platform server can access to retrieve data from) by, for example, a user or a system administrator.

Step 206 requires entry or selection of room information. In instances where room information is not accessible for import to the platform server from an existing database, room information can be manually entered into a database on the platform server by, for example, a system administrator. Step 208 requires capturing a picture of a room. In instances where there are multiple rooms, this step covers capturing pictures for each room, or even a subset of rooms. In some embodiments, room pictures can be imported to the platform server from a remote location on the internet or from local storage on a user or system administrator's computer. In some embodiments, photos associated with specific rooms capture the rooms' nameplates. In some embodiments, multiple photos are taken for each room including a photo of a room's entrance and interior photos of the room (e.g., photos capturing each wall or a 360-degree panorama of the room).

Step 210 requires noting of a photo file name in a room record. This step entails associating a name with a photograph that is associated with a particular room that exists within a particular floor plan. Photo file names can be automatically generated (e.g., sequential room numbering), they can be user- or system administrator-assigned (e.g., “White Oak Conference Room”), or they can be left blank. Step 212 requires adding one or more room assets into the database on the platform server. Room assets can be, for example, hardware, equipment, office supplies, furniture, or any other item that can exist in a room. This step creates an inventory of assets in each room. If a room holds no assets that a user would need access to via the platform server, then this step can be skipped for that room.

When a room has assets that are entered into a database on the platform server, then each asset can have an associated photo. Step 214 requires capturing an asset picture that can be associated with the asset in the platform server's database of assets. An asset photo can be associated with an asset by uploading the asset photo to the platform server (or to a separate photo hosting server) and then associating the photo with a particular asset. This step is not required but can be useful to include to facilitate location and identification of assets in a room by using the photo as a reference.

FIG. 3 shows a flowchart demonstrating how systems and methods of the inventive subject matter carry out data processing, which can be done after the data collection steps are completed. Step 300 requires data to be synced with images. This entails associating data (e.g., information or sets of information relating to any aspect of a building, building development, assets within a building, a region, a location, a structure, a floor, or any other data described in this application). Step 302 requires a floor plan to be uploaded. It is contemplated that this step can additionally or alternatively include retrieving a floor plan from a remote server via, for example, API call or another computer-generated request. Uploading can be completed by, for example, a user or system administrator.

Step 304 requires selection of a primary room image. This can be accomplished by, for example, a user or system administrator. In some embodiments, for each room that is made accessible via systems or methods of the inventive subject matter, a room photograph is associated with the room within the database on the platform server. A room photograph can be hosted on the platform server or on a remote server. This step can be repeated for each room on a floor plan.

Step 306 requires dropping or placing a pin or drawing a room floor plan locator. In this step, room locations are visually identified on a floor plan image. For example, a pin (e.g., a digital pin that can be placed on a map, schematic, or—as in this case—a floor plan) corresponding to a particular room on a floor plan can be dropped or placed on that floor plan to identify the room's location. Thus, when a user accesses a floor plan, one or more pins will appear to identify the various rooms represented on the floor plan. In some embodiment, a room floor plan locator can be drawn. A room floor plan locator performs largely the same function as a pin: it identifies a room on a floor plan. A room floor plan locator can be an outline of a room, or any other type of visual representative capable of facilitating identification of a room location on a floor plan.

Step 308 requires dropping a pin or drawing an asset locator for assets in a room. The concept is similar to the one described above with respect to dropping a pin or drawing a room floor plan locator. For each asset in a room, a pin can be dropped in that room or an asset locator can be drawn in that room. This facilitates visual identification of assets located in each room. It is contemplated that asset pins or asset locators can be added to, for example, a floor plan or to a room photo.

Step 310 requires uploading a 360-degree photo of a room. This step is omitted in some embodiments. The 360-degree photo can either be uploaded from local storage, or it can be imported from a remote server. Step 312, which is only necessary to include in embodiments where step 310 is included, requires a pin to be dropped or placed within the 360-degree photo of the room to indicate a location of an asset. An asset locator pin can be added by a user or system administrator, or, in other embodiments, a machine learning algorithm can identify an asset and automatically place a pin on that asset in the 360-degree photo. It is contemplated that any step requiring a pin to be placed on a visual representation can be carried out by, or with the assistance of, machine learning algorithms.

Step 314 requires selection of a primary asset image. When multiple images exist for a single asset, it can be useful to identify a specific image that will be displayed first when a user accesses an asset using systems or methods of the inventive subject matter. Finally, step 316 requires uploading—or otherwise retrieving from a remote server—all files associated with the identified assets. Associated files can include, for example, manuals, warranty documents, packaging information, SKUs, or any other information associated with the assets.

Once regions, locations, structures, floor plans, room, and assets—along with all associated information—have all been initialized on the platform server, users can access that information using computing devices. Embodiments of the inventive subject matter facilitate access to information stored on the platform server via interactions between client devices and the platform server. For example, in some embodiments when a user accesses the platform, they are presented with a map showing visual representations of different, selectable regions. When a user selects a region, they are then presented with a map showing visual representations of different, selectable locations. When a user selects a location, they are then shown visual representations of structures at that location. Upon selecting a structure, that person can select a floor to be shown a floor plan for that floor. Each floor plan can then include visual representations identifying rooms (e.g., pins), and each room can contain visual representations of assets. It is contemplated that all of these steps can be carried out without the aid of visual representation, instead implementing text-based lists at each step. It is similarly contemplated that the entire process can be carried our visually, without implementing text-based lists, or, in some embodiments, both visual and text-based representations are presented to users.

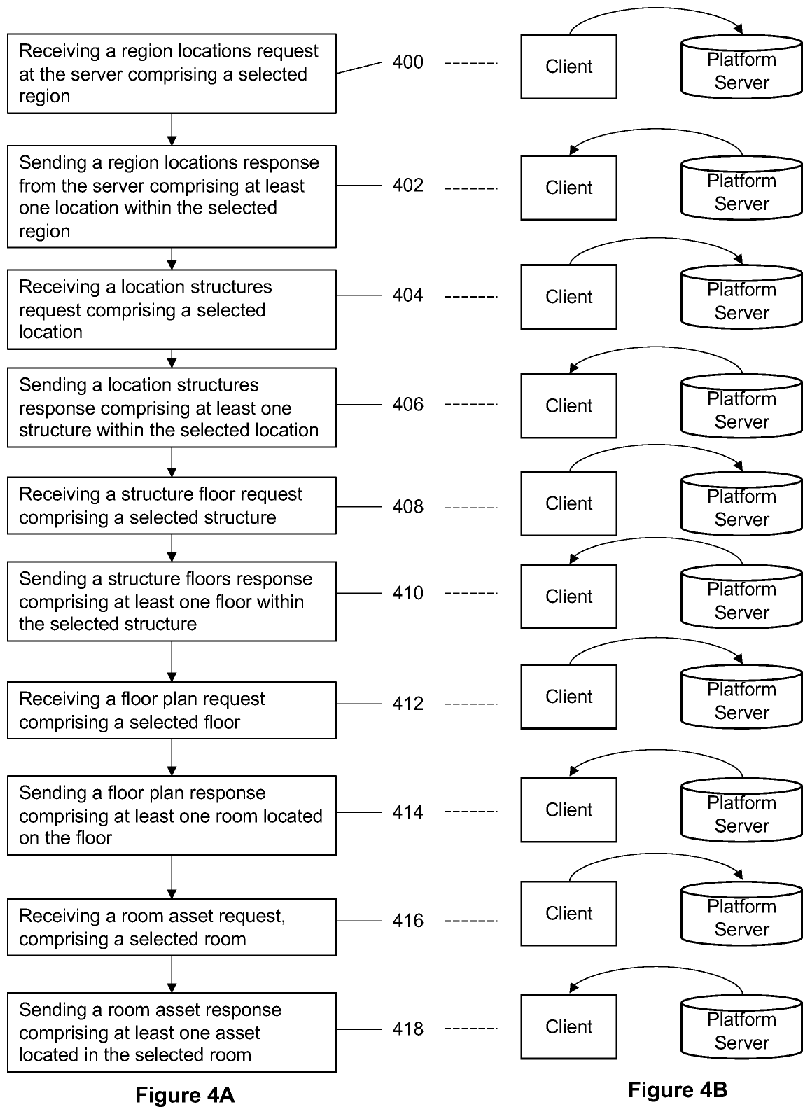

FIGS. 4A and 4B shows a flowchart of an embodiment of the inventive subject matter with accompanying diagrams of how information passes between client devices and the platform server. Step 400 requires receiving, e.g., at the platform server, a region locations request from a client device (e.g., a computing device operated by a person using the platform—when a “user” is mentioned in this context, it can refer to a person operating a computing device). The region locations request includes a selected region. The region selection is made by, for example, a user that is presented with a map showing different regions. The metes and bounds of each region can be user- or system administrator-defined. When a user selects a region (e.g., by clicking on a region), the user's client device sends the region locations request to the server.

In some embodiments, the region locations request additionally includes a load region locations request. The load region locations request asks the platform server to load, for presentation to the user, at least one location corresponding to the selected region (e.g., within the selected region).

Next, step 402 requites the platform server to send a region locations response to the user. The region locations response includes one or more sets location parameters corresponding to locations that are within the selected region. This response enables the user's device to display one or both of a listing of locations and a visual representation of the locations within the selected region. Location parameters can include, for example, a location city, a location description, a location name, a location state, a location structure total, a location zip code, and a region ID. These parameters can be expressed as plaintext, and the parameters can also be encrypted. It is also contemplated that each parameter can be expressed indirectly using unique identifiers corresponding to each parameter. For example, a location state can be expressed as a UUID (Universally Unique ID) where that UUID corresponds to the name of state (e.g., California), instead of having the parameter directly storing the name of the state. The above applies to all parameters disclosed in this application.

Step 404 requires the platform server to receive a location structures request from a user as a consequence of the user selecting a location. The location structures request includes a selected location but can additionally include the selected region. In some embodiments, it also includes a load structures action request to cause the platform server to load one or more sets of structure type parameters and to load one or more sets of structure parameters corresponding to the one or more structures that exist within the selected location.

In response to the location structures request, the platform server, as shown in step 406, sends a location structures response. The location structures response includes sets of structure type parameters and sets of structure parameters corresponding to the structures located with the selected location. A set of structure type parameters corresponds to a particular structure type (e.g., an engineering building, a machine shop, retail space, etc.), and can include, for example, a structure type color (e.g., expressed in hexadecimal or otherwise), a structure type description (e.g., text describing the type of structure), and a structure type label (e.g., a color or wording used to label a structure based on type). Ultimately, a user is presented with one or both of a listing of structures and a visual representation of structures that exist within a selected location.

A set of structure parameters can describe other aspects of a structure located within a location. It can include, for example, a structure city (e.g., the name of a city where a structure is located), a structure description (e.g., a text description of the structure such as “Building 71 on the NHA Black Maple Campus”), a structure location (e.g., a unique identifier corresponding to the structure's location), a structure address (e.g., 123 Halifax Ave), a structure marker position (e.g., latitude and longitude where a marker can be placed on a map to identify the structure's location), a structure name (e.g., Building 71), a structure square footage (e.g., an integer or fractional indication square footage), a structure state (e.g., a plaintext identification of a state or a unique identifier corresponding to a state), a structure type (e.g., corresponding to a structure type as described by a set of structure type parameters mentioned above, which can be expressed as a unique identifier, by plaintext, or otherwise), and a structure zip code (e.g., 20993).

Next, a user must make a structure selection from a listing or visual representation of structures returned by the platform server in the previous steps. Step 408 requires receiving a structure floor request that includes a selected structure. It can additionally include the selected location, the selected region, and, in some embodiments, a load floors action request. The load floors action request causes the platform server to load at least one set of floor parameters corresponding to a floor within the selected structure. The structure floors response allows the user to view one or both of a listing and visual representation of all the floor plans within the selected structure.

In response, as required by step 410, the platform server sends a structure floors response to the user. The structure floors response can include, for example, a set of floor parameters that can include: a floor description (e.g., lobby and reception area with elevator bay.), a floor structure ID (e.g., a UUID), a floor number (e.g., 1), a floor map URL (e.g., null or a URL pointing to a map of the floor), a floor image (e.g., null or an image of the floor), a floor name (e.g., DC0031ZZ-Floor 01), a floor square footage (e.g., an area in square feet or any other unit), and a floor map (e.g., a URL pointing to a map of the floor or the map itself stored directly on the platform server).

As required by step 412, the platform server then receives a floor plan request from a user as a consequence of the user selecting a floor. The floor plan request includes a selected floor, and, in some embodiments, also includes the selected location, the selected structure, and the selected region. In some embodiments, it additionally includes a load rooms action request that causes the platform server to load at least one set of room parameters and to load at least one set of primary use parameters, both corresponding to the selected floor.

Step 414 requires the platform server to send a floor plan response to the user. The floor plan response includes at least one set of room parameters corresponding to a room that exists within the selected floor. The response can also include a set of primary use parameters. The floor plan response allows the user to view one or both of a listing and visual representation of all the rooms within the selected floor plan. A set of room parameters can include: a room layout option, a room link, a primary use, a room map, a room square footage, a room area (e.g., a room's dimensions), a room number, a room name (e.g., DC0031ZZ-Room-0899-19th Corridor AHMR), a room description (e.g., this a room to train new hires), a room capacity, a room image, a room panorama URL, a room parent, a room map URL, and a room floor. A set of primary use parameters can include a primary use color (e.g., a hexadecimal color indicator), a primary use description, and a primary use label (e.g., Machine Room).

Step 416 requires the platform server to receive a room asset request from a user as a consequence of the user selecting a room. The room asset request includes a selected room and can also include, in some embodiments, the selected floor plan, the selected structure, the selected location, and the selected region. In some embodiments, the room asset request can include a load room assets action request to load at least one set of asset parameters and to load at least one set of asset model parameters, both corresponding to at least one asset located in the selected room.

In response, according to step 418, the server sends a room asset response that includes one or more sets of asset parameters and one or more sets of asset model parameters. A set of asset parameters can include: an asset color, an asset description (e.g., motor operated valve), and an asset label (e.g., MOV). A set of asset model parameters can include an asset photo URL (e.g., a URL pointing to a photo of an asset); an asset number; (e.g., 466,101), an asset hotspot; (e.g., coordinates indicating an asset's hotspot, such as the location of a starter switch or a necessary input/output for the asset), an asset model (e.g., a model number for the asset), an asset photo; (e.g., a URL pointing to a photo of the asset), an asset manufacturer, an asset serial number (e.g., DC0031ZZ-MCC-MS-149), an asset QR code, an asset area; (e.g., coordinates indicating where the asset is located within a room), an asset name; (e.g., Motor Starter (3)), an asset parent (e.g., an indication of another asset that is associated with the asset), an asset description (e.g., Motor Starter:100:HP Under:600:Voltage Under), an asset type (e.g., an identifier indicating asset type), and an asset room location (e.g., and indication of the room in which the asset is located)

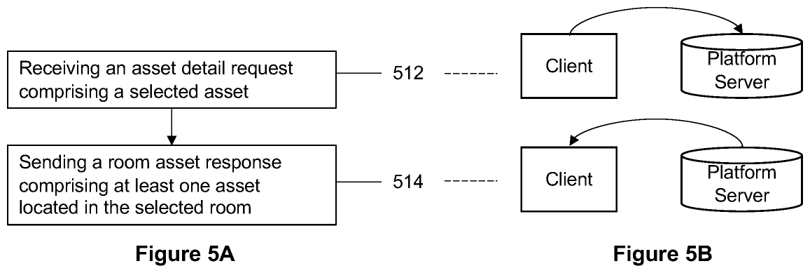

In some embodiments, users can additionally view asset information by selecting an asset, as shown in FIGS. 5A and 5B. Step 500 requires the platform server to receive an asset detail request from a user. The asset detail request can include a selected asset as well as the selected room, the selected floor plan, the selected location, the selected structure, and the selected region. The asset detail request can also include a display asset details action request that ultimately brings about display of a set of asset details corresponding to the selected asset. In response, as required by step 502, the platform server sends an asset detail response that includes information sufficient to cause the user's device to display a set of asset details corresponding to the selected asset. In some embodiments, a set of asset details comprises one or both of a set of asset parameters and a set of asset model parameters.

Thus, specific compositions and methods of nested asset organization and management have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of accessing development project assets, comprising the steps of:
receiving a region locations request at the server, the region locations request comprising a selected region;
sending a region locations response from the server, the region locations response comprising at least one set of location parameters corresponding to the at least one location located in the selected region;
receiving a location structures request comprising a selected location and the selected region;
sending a location structures response comprising at least one set of structure type parameters and at least one set of structure parameters;
receiving a structure floor request comprising, a selected structure, the selected location, and the selected region;
sending a structure floors response comprising at least one set of floor parameters;
receiving a floor plan request, comprising, a selected floor, the selected location, the selected structure, and the selected region;
sending a floor plan response, comprising at least one set of room parameters and at least one set of primary use parameters;
receiving a room asset request, comprising, a selected room, the selected floor plan, the selected location, the selected structure, and the selected region; and
sending a room asset response, comprising at least one set of asset parameters and at least one set of asset model parameters.

2. The method of claim 1, wherein the region locations request further comprises a load region locations request to load at least one location corresponding to the selected region.

3. The method of claim 1, wherein the at least one set of location parameters comprises at least one of a location city, a location description, a location name, a location state, a location structure total, a location zip code, and a region ID.

4. The method of claim 1, wherein the load structures request further comprises a load structures action request to load the at least one set of structure type parameters and to load the at least one set of structure parameters, both corresponding to the selected location.

5. The method of claim 1, wherein the at least one set of structure type parameters comprises at least one of a structure type color, a structure type description, and a structure type label.

6. The method of claim 1, wherein the at least one set of structure parameters comprises at least one of a structure city, a structure description, a structure location, a structure address, a structure marker position, a structure name, a structure square footage, a structure state, a structure type, and a structure zip code.

7. The method of claim 1, wherein the structure floors request further comprises a load floors action request to load the at least one set of floor parameters corresponding to a floor within the selected structure.

8. The method of claim 1, wherein the at least one set of floor parameters comprises at least one of a floor description, a floor structure ID, the dataset ID, a floor number, a floor map URL, a floor image, a floor name, a floor square footage, and a floor map.

9. The method of claim 1, wherein the floor plan request further comprises a load rooms action request to load the at least one set of room parameters and to load the at least one set of primary use parameters, both corresponding to the selected floor.

10. The method of claim 1, wherein the at least one set of room parameters comprises at least one of a room layout option, a room link, a primary use, a room map, a room square footage, a room area, a room number, a room name, a room description, a room capacity, a room image, a room panorama URL, a room parent, a room map URL, and a room floor.

11. The method of claim 1, wherein the at least one set of primary use parameters comprises at least one of a primary use color, a primary use description, and a primary use label.

12. The method of claim 1, wherein the room asset request further comprises a load room assets action request to load the at least one set of asset parameters and to load the at least one set of asset model parameters, both corresponding to at least one asset located in the selected room.

13. The method of claim 1, wherein the at least one set of asset parameters comprises at least one of an asset color, an asset description, and an asset label.

14. The method of claim 1, wherein the at least one set of asset model parameters comprises at least one of: an asset photo URL, an asset number, an asset hotspot, an asset model, an asset photo, an asset manufacturer, an asset serial number, an asset QR code, an asset area, an asset name, an asset parent, an asset description, an asset type, and an asset room location.

15. The method of claim 1, further comprising the steps of:
receiving an asset detail request, comprising:
a selected asset;
the selected room;
the selected floor plan;
the selected location;
the selected structure;
the selected region;
a display asset details action request to cause display of a set of asset details corresponding to the selected asset; and
sending an asset detail response comprising information sufficient to cause display of the set of asset details on a computing device.
